(19) United States
(12) Patent Application Publication
(10) Pub. No.: US 2002/0126964 A1
(43) Pub. Date: Sep. 12, 2002

(54) Optical coupling

(75) Inventors: Claes Bertil Blom, Skuminge (SE); Anders Stefan Andersson, Spaga (SE)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor AB, Jarfalla (SE)

(21) Appl. No.: 10/090,020

(22) Filed: Mar. 5, 2002

(30) Foreign Application Priority Data
Mar. 10, 2001 (GB) 0105968.2

(51) Int. Cl. G02B 6/36; G02B 6/38; G02B 6/42

(52) U.S. Cl. 385/88; 385/73

(57) ABSTRACT

An optical connector includes a supporting block, a pair of guide pins protruding from the supporting block for mating with a connecting component, and an array of active optical components recessed into the supporting block so that a void is present between the active optical components and optic fibers carried by the connecting component. A transparent filler material the void and provides a light path between the active optical components and the optic fibers.

### FIELD OF THE INVENTION

This invention relates to the field of fiber optic communications, and in particular to a method of coupling optical fibers together or to a light transmitter or receiver. The invention is applicable to multi-channel high speed optical devices.

### BACKGROUND OF THE INVENTION

In the field of fiber optic communications, there is a need to connect fibers together or to connect fibers to active optical devices, such as transmitters and receivers. It is common practice to connect fibers together by bringing their ends into close abutting relationship without any kind of filling between the abutting ends. It is also known to use silicone to fill the small air gap between the fiber ends.

In the case of optical modules with several optical channels it is very important to ensure that the behaviour of the channels is as similar as possible in order to simplify the setup procedure for the driver circuits and transimpedance amplifiers. One possibility is to cover the active areas of optical modules with silicone, see, for example, U.S. Pat. No. 6,170,996, but this arrangement will give the surface an unwanted curvature, which will cause some of the light to be reflected at uncontrolled angles.

MT-RJ is a connection system which provides a comprehensive, end-to-end solution for the installation of fiber-optic cable to computers and local area network (LAN) equipment. If for example an MT contact is used to couple light from a laser or other electro-optical component to one or more fibers there will be an air gap of different size between the component and fiber. The situation will be the same if an opto-electric receiver of some kind is used. The contact will come very close to the optical interface and this can be a mechanical problem if the contact is inserted and released several times and the silicone reaches the contact causing stress on the optical chip.

An object of the invention is to address these problems.

### SUMMARY OF THE INVENTION

In order to solve the aforementioned problems an unfilled area between one or more opto-electrical chips and one or more fibers is filled with cured or uncured silicone or like material to provide an uninterrupted optical path. This is achieved using a standard MT or other optical contact.

Accordingly the present invention provides an optical connector comprising a supporting block, a pair of guide pins protruding from said mounting block for mating with a connecting component, an array of active optical components recessed into said supporting block so that a void is present between said active optical components and optic fibers carried by said connecting component, and a transparent filler material filling said void and providing a light path between said active optical components and said optic fibers.

The transparent filler material is preferably silicone although other suitable transparent materials, such as BCB, Benzo Cyclo Butane.

By filling the voids in this manner the invention completely avoids the problem of reflection arising from the wavy surfaces formed in the prior art arrangements. It has also been found unexpectedly that the power output from the lasers is substantially increased when the voids are filled in this way.

The invention also provides an optical coupling comprising a first connector portion and a second connector portion mating with said first connector portion, said first connector portion comprising mounting block; a pair of guide pins protruding from said mounting block; an array of active optical components recessed into said mounting block; and said second connector portion comprising a supporting block; a bundle of optic fibers carried by said supporting block terminating at an end face of said supporting block; and wherein a void is present between said active optical components and said end face of said supporting block, and a transparent filler material fills said void to provide a light path between said active optical components and said optic fibers.

### BRIEF DESCRIPTION OF THE DRAWINGS

The invention will now be described in more detail, by way of example only, with reference to the accompanying drawings, in which:

FIG. 1 shows an optical connector in accordance with the prior art;

FIG. 2 shows a first embodiment of an optical connector in accordance with the invention;

FIG. 3 shows as a second embodiment of an optical connector in accordance with the invention; and

FIG. 4 shows an arrangement employing an optical connector in accordance with the invention.

### DETAILED DESCRIPTION OF THE PREFERRED EMBODIMENTS

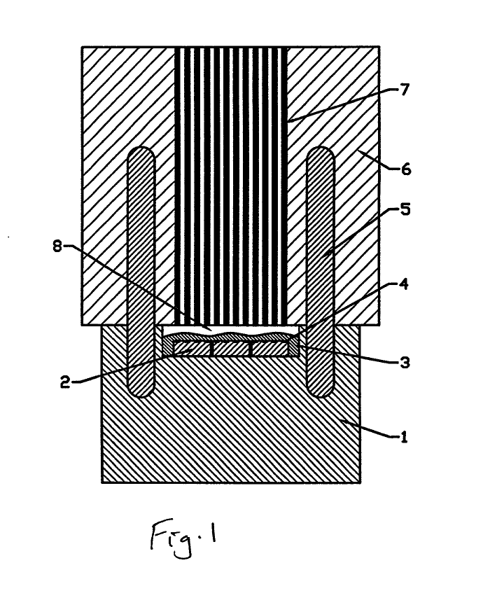

Referring to FIG. 1, a heat sink 1 for an optical transceiver has rigid guide pins 5 mounted therein. Three electro-optical chips 2, for example comprising VCSEL optical transmitters, are mounted on the heat sink 1.

An optical connector 6 is guided by the pins 5 mounted in the heat sink so that the optic fibers 7 are accurately aligned with the active areas 4 of the individual chips. The optical path from the active area of one of the opto-electrical chips 4 passes through the silicone layer 3 and the air gap 8 to the optical fiber 7.

In such an arrangement the inventors have discovered that the upper surface of the silicone layer 3 is wavy as shown, and that this causes light to be reflected at uncontrolled angles.

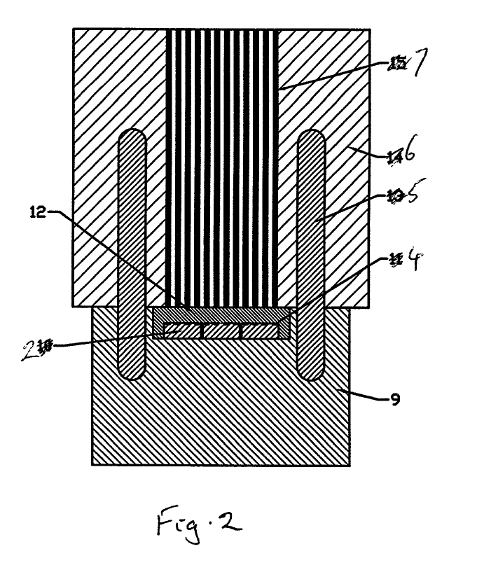

In accordance with the principles of the invention, as shown in FIG. 2, the entire void between the active areas 4 and the optic fibers 15 is filled with silicone 12. This may be cured or uncured silicone. It provides an unbroken light path from the active area 4 into the optic fibers 7. It will be seen that no wavy surfaces are present and as a result the problem with unwanted reflections can be avoided.

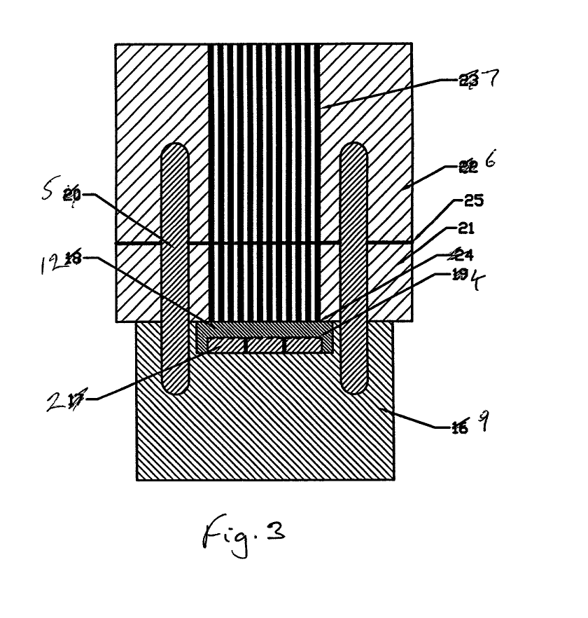

FIG. 3 shows an arrangement where the waveguide is sliced along line 25. The optical path extends through the silicone 12 to the optic fiber stubs in the lower part of the connector 21. heat sink 16 with its rigid mounted guide pins 20. In the heat sink 16 are three electro-optical chips mounted with one of its chip 17 The optical contact 22 is guided by the p ns 20 sitting in the heat sink. The optical path from one of the opto-electrical clips active area 19 is going through the silicone 18 and passing the sliced waveguide 21 to the optical fiber 23.

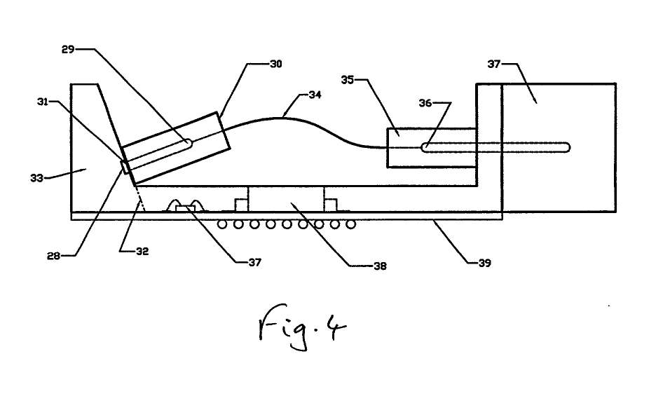

FIG. 4 shows a device where the earlier described silicone path is used in an optoelectrical module for high speed data up to 10 Gbit/s. The heat sink 33 has rigid mounted guide pins 29. In the heat sink 33 are provided one or more electo-optical chips 28 and the path between the chip active area is filled with silicone 31 as earlier described with reference to FIG. 2 or a short slice of waveguide as described with reference to FIG. 3. From here the light is transmitted, or received in the case of a receiver, or in both directions in the case of a transceiver to the optical fiber 34 sitting in the optical contact 30 and further to another optical contact 35 provided with its own guide pins 36. Another optical contact can be inserted in the cover 37 an is guided by the guide pins 36 sitting in the optical contact 35. The one or more electro-optical chips have a leadframe 32 which carries electrical signals down to the printed circuit board 39. Electrical chips 37 and 38 flip chip, wirebonded or soldered to the circuit board 39.

The described arrangement ensures very efficient coupling of the light through the device at high data rates in the order of 10 Gbits.

It will be appreciated that the principles in accordance with the invention can be applied to optic fibers that need to be coupled together. In this case, the ends are brought into close proximity, supported by a supporting block as desired in such a way as to provide a small void between the ends. This void is then filled with transparent silicone material as described above to complete the light path between the fibers.

It will also be appreciated by persons skilled in the art that other suitable transparent filler materials can be employed in the place of silicone. For example, many resins are well suited to this application.

1. An optical connector comprising a supporting block, a pair of guide pins protruding from said mounting block for mating with a connecting component, an array of active optical components recessed into said supporting block so that a void is present between said active optical components and optic fibers carried by said connecting component, and a transparent filler material filling said void and providing a light path between said active optical components and said optic fibers.

2. An optical connector as claimed in claim 1, wherein said transparent filler material is silicone.

3. An optical connector as claimed in claim 2, wherein said mounting block is a heat sink.

4. An optical coupling comprising a first connector portion and a second connector portion mating with said first connector portion, said first connector portion comprising:
mounting block;
a pair of guide pins protruding from said mounting block;
an array of active optical components recessed into said mounting block; and
said second connector portion comprising:
a supporting block;
a bundle of optic fibers carried by said supporting block terminating at an end face of said supporting block; and
wherein a void is present between said active optical components and said end face of said supporting block, and a transparent filler material fills said void to provide a light path between said active optical components and said optic fibers.

5. An optical coupling as claimed in claim 4, wherein said transparent filler material is silicone.

6. An optical coupling as claimed in claim 5, wherein said supporting block of said second portion is transversely sliced.

7. An optical coupling comprising a pair of optical fibers with abutting ends defining a void therebetween, and a transparent filler material in said void to couple said optical fibers together.
